(19) United States
(12) Patent Application Publication
(10) Pub. No.: US 2020/0111112 A1
(43) Pub. Date: Apr. 9, 2020

(54) SYSTEM AND METHOD FOR EVENT TICKETING

(71) Applicant: Ronald William Warner, Avon lake, OH (US)

(72) Inventor: Ronald William Warner, Avon lake, OH (US)

(21) Appl. No.: 16/594,413

(22) Filed: Oct. 7, 2019

Related U.S. Application Data
(60) Provisional application No. 62/742,618, filed on Oct. 8, 2018.

(51) Int. Cl. G06Q 30/02; G06Q 10/02

(52) U.S. Cl. CPC G06Q 30/0206; G06Q 10/02

(57) ABSTRACT

A system and method for event ticketing is provided. The system and method may include acquiring a ticket for an event, determining a start time of the event, establishing a sale price of the ticket for the event, offering the ticket for sale at the sale price, and providing a purchaser of the ticket access to the event after the start time of the event. The system and method may include acquiring a ticket for an event, determining a start time of the event, establishing a sale price of the ticket for the event, establishing a pre-determined portion of access to the event, offering the ticket for sale at the sale price, and providing a purchaser of the ticket the pre-determined portion of access to the event.

### CROSS REFERENCE TO RELATED APPLICATIONS

This application claims the benefit of U.S. Provisional Patent Application Ser. No. 62/742,618, filed on Oct. 8, 2018; the disclosure of which is incorporated herein by reference.

### TECHNICAL FIELD

The present disclosure relates generally to event ticketing. More particularly, the present disclosure relates to offering tickets for sale before and after a start time of an event. Specifically, the present disclosure relates to acquiring tickets for events and offering the tickets for sale before and after a start time of the event at adjustable prices.

### BACKGROUND

### Background Information

Generally, tickets for events, such as entertainment events, are sold by primary ticket vendors and secondary ticket vendors to purchasers of the tickets. Tickets for the event are typically sold at face value (i.e., the price indicated on the ticket), which is usually set by a provider of the event, or at a pre-determined discount up until the event starts. As such, ticket purchasers typically purchase tickets prior to the start of the event and typically arrive before the event starts in order to receive full value for the tickets purchased.

### SUMMARY

Issues continue to exist with systems and methods for event ticketing. The present disclosure provides a system and method for event ticketing including, at least in part, acquiring tickets for events and offering the tickets for sale before and after a start time of the event at adjustable prices.

In one aspect, the present disclosure may provide a method comprising acquiring a ticket for an event, determining a start time of the event, determining a first sale price of the ticket for the event, establishing, with at least one processor, a subsequent sale price of the ticket for the event, and offering, with the at least one processor, the ticket for sale at the subsequent sale price to provide access to the event after the start time of the event.

In another aspect, the present disclosure may provide a method comprising acquiring a ticket for an event, determining a start time of the event, determining a first sale price of the ticket for the event, establishing, with at least one processor, a subsequent sale price of the ticket for the event, and offering, with at least one processor, the ticket for sale at the subsequent sale price prior to the start time of the event for access to a pre-determined portion of the event after the start time of the event.

In another aspect, the present disclosure may provide a system comprising at least one non-transitory computer-readable storage medium, and at least one processor or microprocessor. The at least one non-transitory computer-readable storage medium may include instructions encoded thereon that when executed by at least one processor operates to acquire a ticket for an event, determine a start time of the event, determine a first sale price, which may also be referred to as FSP, of the ticket for the event, establish a subsequent sale price, which may also be referred to as SSP, of the ticket for the event, and offer the ticket for sale at the subsequent sale price at a time after the start time of the event, or any other suitable time. The at least one non-transitory computer-readable storage medium having instructions encoded thereon and the at least one processor may be configured to operatively communicate with a website, a mobile application, or any other suitable mechanism.

In another aspect, the present disclosure may provide a system and method for event ticketing. The system and method may include acquiring a ticket for an event, determining a start time of the event, determining a first sale price of the ticket for the event, establishing, with at least one processor, a subsequent sale price of the ticket for the event, and offering, with the at least one processor, the ticket for sale at the subsequent sale price to provide access to the event after the start time of the event. In another example, the method comprises offering, with at least one processor, the ticket for sale at the subsequent sale price prior to the start time of the event for access to a pre-determined portion of the event after the start time of the event.

In another aspect, the present disclosure may provide a method for event ticketing comprising acquiring a ticket for an event; determining a start time of the event; establishing a sale price of the ticket for the event; offering the ticket for sale at the sale price; and providing a purchaser of the ticket access to the event after the start time of the event. In one example, the offering the ticket for sale at the sale price occurs subsequent to the start time of the event.

In one example, the method further includes determining a face value of the ticket and establishing the sale price to be higher than the face value. In another example, the method further includes determining a face value of the ticket and establishing the sale price to be lower than the face value. In one example, the method includes dynamically adjusting the sale price after the start time of the event. In one example, the acquiring the ticket for the event is accomplished via obtaining the ticket from at least one of a primary ticket vendor, a secondary ticket vendor, and a person who previously purchased the ticket.

The method further includes providing a ticketing interface. The acquiring the ticket for the event is accomplished via importing the ticket into a database via the ticketing interface. The method includes allowing the purchaser of the ticket to purchase the ticket through operative communication with a user interface. In one example, the user interface is a website. In another example, the user interface is a mobile application.

In another aspect, the present disclosure may provide a method for event ticketing comprising acquiring a ticket for an event; determining a start time of the event; establishing a sale price of the ticket for the event; establishing a pre-determined portion of access to the event; offering the ticket for sale at the sale price; and providing a purchaser of the ticket the pre-determined portion of access to the event. In one example, the offering the ticket for sale at the sale price occurs prior to the start time of the event.

In one example, the method further includes determining a face value of the ticket and establishing the sale price to be higher than the face value. In another example, the method further includes determining a face value of the ticket and establishing the sale price to be lower than the face value. In one example, the method includes dynamically adjusting the sale price after the start time of the event. In one example, the acquiring the ticket for the event is accomplished via obtaining the ticket from at least one of a primary ticket vendor, a secondary ticket vendor, and a person who previously purchased the ticket.

The method further includes providing a ticketing interface. The acquiring the ticket for the event is accomplished via importing the ticket into a database via the ticketing interface. The method includes allowing the purchaser of the ticket to purchase the ticket through operative communication with a user interface. In one example, the user interface is a website. In another example, the user interface is a mobile application.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a flow chart of one method or process in accordance with the present disclosure;

FIG. 2 is an exemplary system in accordance with one aspect of the present disclosure;

FIG. 3 is an exemplary screen view of a login page of an event ticketing application displayed on an electronic device;

FIG. 4 is an exemplary screen view of a user name text box and a password text box of the event ticketing application displayed on the electronic device;

FIG. 5 is an exemplary screen view of a menu screen of the event ticketing application displayed on the electronic device;

FIG. 6 is an exemplary screen view of a location selection screen of the event ticketing application displayed on the electronic device;

FIG. 7 is an exemplary screen view of a date selection screen of the event ticketing application displayed on the electronic device;

FIG. 8 is an exemplary screen view of an event screen of the event ticketing application displayed on the electronic device;

FIG. 9 is an exemplary screen view of a seat selection screen of the event ticketing application displayed on the electronic device;

FIG. 10 is an exemplary screen view of an order information screen of the event ticketing application displayed on the electronic device;

FIG. 11 is an exemplary screen view of a payment screen of the event ticketing application displayed on the electronic device;

FIG. 12 is an exemplary screen view of a receipt screen of the event ticketing application displayed on the electronic device; and

FIG. 13 is an exemplary screen view of a ticket screen of the event ticketing application displayed on the electronic device.

Similar numbers refer to similar parts throughout the drawings.

### DETAILED DESCRIPTION

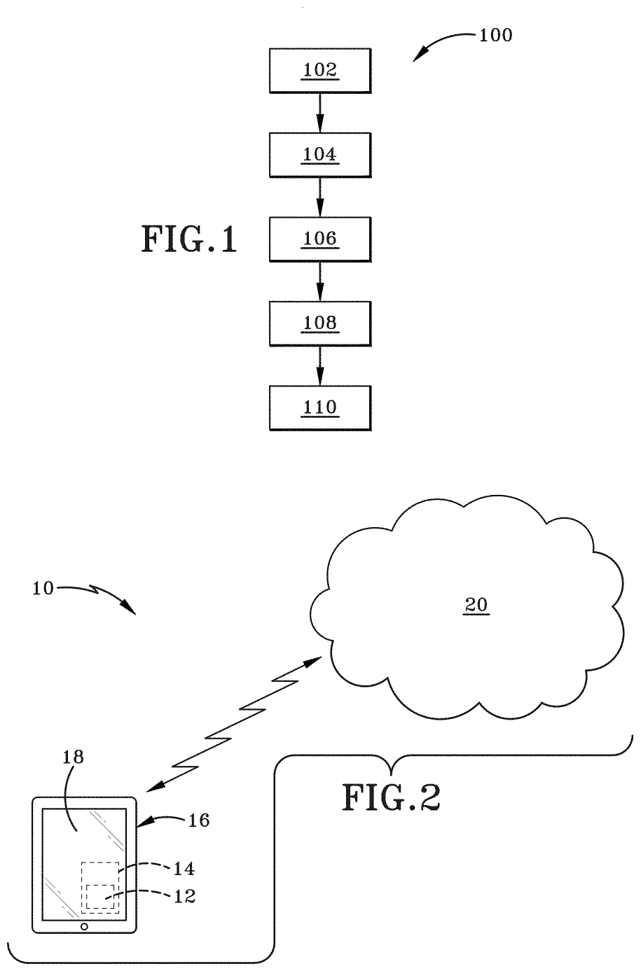

As depicted throughout the figures, a system and method for event ticketing is provided herein. FIG. 1 is a flow chart of one method or process in accordance with the present disclosure and is generally indicated at 100.

The method 100 includes acquiring a ticket for an event, which is shown generally at 102. Tickets for events may be acquired in various ways. For example, tickets may be acquired directly from a primary ticket vendor and/or a secondary ticket vendor. A primary ticket vendor is defined as a source of tickets sold directly into a retail market. A secondary ticket vendor is defined as source of tickets offering the tickets for resale after purchase from a primary ticket vendor or other source of tickets.

Tickets sold by primary ticket vendors are typically sold for the first time at face value (i.e., the price indicated on the ticket), which is initially set by a provider of the event, or at a pre-determined discount up until the event starts. Exemplary primary ticket vendors include, but are not limited to, sports teams, ticket broker services, such as TICKETMASTER® (TICKETMASTER® is a trademark owned by Live Nation Entertainment, Inc.), or any other source of tickets sold directly into the retail market. Tickets sold by secondary ticket vendors are sold at various prices, such as, for example, higher or lower than face value up until the start of the events. Exemplary secondary ticket vendors include, but are not limited to, ticket broker services, such as STUBHUB® (STUBHUB® is a registered trademark of StubHub, Inc.), or any other source of tickets that are offered for resale.

The ticket may be acquired from the primary ticket vendor and/or the secondary ticket vendor in various ways. For example, the ticket may be acquired through operative communication with an application program interface (API), through operative communication with a ticket broker service (e.g. integration with technology utilized by the ticket broker service), through operative communication with possessors of tickets who desire to sell their tickets (e.g., consumers who purchased a ticket from a primary ticket vendor or a secondary ticket vendor), or through any other suitable manner. In one example, the acquired tickets are stored in a database accessible by the system and methods of the present disclosure; however, the acquired tickets may be stored and/or accessible in any suitable manner.

The acquired ticket may take on various forms. For example, the acquired ticket may be an electronic ticket or a physical ticket. The electronic or physical ticket includes information allowing a possessor of the ticket to access the event associated with the acquired ticket. Although the acquired tickets have been described as being electronic tickets or paper tickets, the acquired tickets may be any suitable mechanism allowing possessors of the acquired tickets access to events associated with the acquired tickets.

The ticket may be acquired at any time before the event associated with the acquired ticket is completed. Although the acquired ticket has been described as being acquired at any time before the event associated with the acquired ticket is completed, it is to be understood that the ticket may be acquired at any suitable time.

The method 100 includes determining a start time of the event associated with the acquired ticket, which is shown generally at 104. The method 100 includes determining a first sale price, which may also be referred to as FSP, of the acquired ticket, which is shown generally at 106. In one example, the first sale price represents the face value of the ticket. In another example, the first sale price of the acquired ticket represents the sale price of the acquired ticket at any time prior to the start time of the associated event.

The method 100 includes establishing a subsequent sale price, which may also be referred to as SSP, of the acquired ticket for the associated event, which is shown generally at 108. In one example, the subsequent sale price of the acquired ticket represents the sale price of the acquired ticket after a start time of the event associated with the acquired ticket. The subsequent sale price may be established in any suitable manner and may be adjustable during the time period after the start time of the associated event.

In one example, the subsequent sale price of the acquired ticket for the associated event may be lower than the first sale price of the acquired ticket. For example, and not meant as a limitation, the subsequent sale price may be established based, at least in part, on the following equation:

SSP=FSP−(AV×ET) (Equation 1)

where AV is adjustment value and ET is elapsed time from the start time of the associated event to a time subsequent to the start time of the associated event.

In one example, the adjustment value may be a variable represented as a number or a percentage, and may be based on at least the following: the type of associated event; the perceived value of the associated event (e.g., if the associated event is a baseball event, a championship game may be perceived as having a higher value than a regular season game); previous sales data related to the associated event or similar events; seat location; status of season of the associated event (e.g., if the associated event is a baseball event, the status of season may be early or late in the season and late season games may be perceived as having higher value than early season games); and popularity of the associated event (e.g., if the event is a concert and the performer is performing their last show, the event may be perceived as having a higher value than if the performer was performing their first show). Although some exemplary parameters/factors that influence the adjustment value have been identified, the adjustment value may be any suitable value and may be established in any suitable manner.

In one example, the elapsed time of the associated event is based, at least in part, on a time between the start time of the associated event and a time subsequent to the start time of the associated event. For example, and not meant as a limitation, if the event is a concert, and the start time of the event is 9:30 pm Eastern Standard Time (EST), and the second time is 10:00 pm (EST), the elapsed time would be thirty minutes.

In another example, the elapsed time of the associated event is based, at least in part, on a current status of the associated event. For example, and not meant as a limitation, if the associated event is a baseball event, the elapsed time of the baseball event may be based on how many innings have been completed. If the associated event is a football event, the elapsed time of the football event may be based on how many quarters or halves have been completed. If the associated event is a hockey event, the elapsed time of the hockey event may be based on how many periods have been completed. If the associated event is a basketball event, the elapsed time of the basketball event may be based on how many quarters or halves have been completed. Although certain descriptions of elapsed time have been provided, the elapsed time may be established in any suitable manner.

In another example, the subsequent sale price of the acquired ticket may be higher than the first sale price of the acquired ticket. For example, and not meant as a limitation, the subsequent sale price may be based on the following equation:

SSP=FSP+(AV×ET) (Equation 2)

where AV is adjustment value and ET is elapsed time from the start time of the associated event to a time subsequent to the start time of the associated event, each of which have been discussed in greater detail above and apply in a similar manner to this scenario.

Although exemplary methods of establishing the subsequent sale price have been provided, it is to be fully understood that the subsequent sale price may be established in any suitable manner.

The method 100 further includes offering the acquired ticket for sale at the subsequent sale price at a time subsequent to the start time of the associated event, which is shown generally at 110. The time that the acquired ticket is offered for sale may be determined in various ways. For example, and not meant as a limitation, a primary ticket vendor or a secondary ticket vendor possessing an unsold ticket for an event may desire to utilize the method 100 and offer the ticket for the event after the start time of the event. This is beneficial as a primary ticket vendor or a secondary ticket vendor is typically not able to sell an unsold ticket once the start time of the event has passed. This is also beneficial because the ticket may be purchased by a purchaser who desires to attend at least a portion of the event at the subsequent sale price, which, in one example, is at a reduced price compared to the first sale price.

In another example, a purchaser of a ticket for the event may attend only a portion of the event and may desire to utilize the method 100 and offer the ticket for the event after the start time of the event. For example, and not meant as a limitation, if the event is a baseball event, the purchaser may attend the first three innings of the baseball event and then may utilize the method 100 to offer the ticket for the baseball event for sale at the subsequent sale price from the fourth inning, or any inning after the third inning, to completion of the baseball event. This is beneficial as a purchaser of a ticket who only attends a portion of the event is typically not able to sell the ticket for access to the remaining portion of the event. This is also beneficial because the ticket may be purchased by a purchaser who desires to attend at least a portion of the event at the subsequent sale price, which, in one example, is at a reduced price compared to the first sale price.

The method 100 may offer the acquired ticket for sale at the subsequent sale price at a time subsequent to the start time of the associated event in various ways. For example, the acquired ticket may be offered for sale through operative communication with a website or through operative communication with a mobile application accessible by an electronic device. The website may be any suitable website, the mobile application may be any suitable mobile application, and the electronic device may be any device capable of executing software instructions. For example, and not meant as a limitation, the electronic device may be a smart phone, computer, laptop computer, or the like.

As stated above, the subsequent sale price of the acquired ticket represents the sale price of the acquired ticket after a start time of the event associated with the acquired ticket. Further, and as stated above, that the subsequent sale price may be established in any suitable manner. As such, and in one example, the subsequent sale price may also be referred to as sale price, and the sale price does not have to be related to the first sale price in any manner whatsoever and may be established in any suitable manner.

An exemplary application of the above-described method 100 for event ticketing will be provided herein. In this example, the method 100 will be applied to an acquired ticket for a baseball event having at least nine innings of play. Although the method 100 is being described in relation to a baseball event, it is to be fully understood that the method 100 may be applied to any suitable event.

In this example, the method 100 includes acquiring a ticket for a baseball event from a primary ticket vendor or a secondary ticket vendor. The acquired ticket for the baseball event is acquired at any time before the baseball event is completed. For example, and not meant as a limitation, the ticket may be acquired from a primary ticket vendor or a secondary ticket vendor before the baseball event starts or after the baseball event starts up until the completion of the baseball game. The method 100 includes determining a start time of the baseball event. In this example, the start time of the baseball event is 7:05 pm Eastern Standard Time (EST). The method 100 includes determining a first sale price, or an FSP, of the acquired ticket for the baseball event. The first sale price of the acquired ticket for the baseball event is the face value of the acquired ticket established by the event provider, and, for exemplary purposes, the face value in this example is $54.00. The method 100 includes establishing a subsequent sale price, or SSP, of the acquired ticket for the baseball event. The acquired ticket is offered for sale at the subsequent sale price after a start time of the baseball event and the subsequent sale price is adjustable during the period of time after the start time of the baseball event. Therefore, the subsequent sale price of the acquired ticket for the baseball event may vary at different times subsequent to the start time of the baseball event. Stated otherwise, the acquired ticket may be offered for sale throughout the baseball event at varying and/or dynamic prices. Some exemplary ticket offerings in accordance with the method 100 are described below.

In one example, the acquired ticket for the baseball event is offered for sale at the subsequent sale price at any time prior to the fourth inning of play. The determination of when to offer the acquired ticket for sale may be made by the person or company desiring to sell the acquired ticket for the baseball event. For example, and not meant as a limitation, the determination of when to offer the acquired ticket for the baseball event for sale may be made by a primary or secondary ticket vendor possessing an unsold ticket, or by a purchaser of the ticket who is only able to attend the first two innings of the baseball event.

In this example, the subsequent sale price is established in accordance with Equation 1 as follows: SSP=$54.00−(54× 3/9)=$36, where the adjustment value is 54 and the elapsed time is based on how many innings have been completed or how many innings are left to be completed. In this example, three out of nine innings of the baseball event have been completed. Therefore, the acquired ticket for the baseball event may be offered for sale at the subsequent sale price, which is a reduced price compared to the first sale price, at any time before the fourth inning, and, if the acquired ticket for the baseball event is purchased by the purchaser at this time, the purchaser may attend the game from the fourth inning through completion of the baseball event.

In another example, the ticket for the baseball event is offered for sale at the subsequent sale price at any time before the seventh inning of play. The determination of when to offer the ticket for the baseball event for sale may be made in a similar manner as described above. In this example, the subsequent sale price is established in accordance with Equation 1 as follows: SSP=$54.00−(54× 6/9)=$18 where the adjustment value is 54 and the elapsed time is based on how many innings have been completed or how many innings are left to be completed, which, in this example, six out of nine innings have been completed. Therefore, the ticket for the baseball event may be offered for sale at the subsequent sale price, which is a reduced price compared to the first sale price, at any time before the seventh inning of play, and, if the ticket for the baseball event is purchased by the purchaser at this time, the purchaser may attend the game from the seventh inning through completion of the baseball event.

The method 100 for event ticketing may be utilized to offer acquired tickets for the baseball event for sale at any time subsequent to the start time of the baseball event through completion of the baseball event. Although exemplary numbers have been used for the adjustment value and the elapsed time, the adjustment value and the elapsed time may be any suitable values. Further, although examples of the subsequent sale price being established in accordance with Equation 1 have been described, the subsequent sale price does not have to be established in accordance with Equation 1 and may be established in any suitable manner. Still further, although the method 100 has been described as being utilized with acquired tickets for a baseball event, the method 100 may be utilized with any acquired tickets and their associated events.

In another example, the ticket for the baseball event may be offered for sale at the subsequent sale price during the seventh inning of play. The determination of when to offer the ticket for the baseball event for sale may be made by the person or company desiring to sell the ticket for the baseball event. In this example, the subsequent sale price increases compared to the first sale price due to occurrences during the baseball event. For example, and not meant as a limitation, if a baseball team is in the process of mounting a comeback towards the end of the baseball event, the demand for tickets to attend the event may increase. In this example, the subsequent sale price is established in accordance with Equation 2 as follows: SSP=$54.00+(30× 7/9)=$77.33 where the adjustment value is 30 and the elapsed time is seven out of nine innings completed. Therefore, the ticket may be offered for sale at an increased price compared to the first sale price during the seventh inning of play, and, if the ticket is bought by the purchaser at this time, the purchaser may attend the game from the seventh inning through completion of the baseball event.

A second method or process in accordance with the present disclosure is disclosed herein. The second method is similar to method 100; however, instead of offering the acquired ticket for sale at the subsequent sale price at a time subsequent to the start time of the associated event, the acquired ticket is offered for sale at the subsequent sale price prior to the start time of the associated event for a pre-determined portion of access to the associated event after the start time of the associated event. The determination of what pre-determined portion of access to the associated event to offer access to may be made by the person or company desiring to sell the ticket for the baseball event.

For example, and not meant as a limitation, determining what pre-determined portion of access to the event to offer may be made by a primary or secondary ticket vendor possessing an unsold ticket, or by a purchaser of the ticket who is only able to attend a portion of the event and desires to make the pre-determined portion of access to the event available for purchase by another. This is beneficial because it allows the seller of the ticket to offer a pre-determined portion of access to the event at prices that reflect the value of the tickets being sold that may otherwise go unsold. This is also beneficial because it allows a purchaser of the ticket to attend a pre-determined portion of access to the event for a price that reflects the value of the tickets, which, in one example, is less than the face value of the tickets.

As stated above, the subsequent sale price of the acquired ticket represents the sale price of the acquired ticket after a start time of the event associated with the acquired ticket. Further, and as stated above, that the subsequent sale price may be established in any suitable manner. As such, and in one example, the subsequent sale price may also be referred to as sale price, and the sale price does not have to be related to the first sale price in any manner whatsoever and may be established in any suitable manner.

An exemplary application of the second method for event ticketing will be provided herein. In this example, the second method will be applied to an acquired ticket for a baseball event having at least nine innings of play. Although the second method is being described in relation to a baseball event, it is to be fully understood that the second method may be applied to any suitable event.

For example, and not meant as a limitation, the acquired ticket is offered for sale at the subsequent sale price before the start time of the baseball event for a pre-determined portion of access to the baseball event after the start time of the event. In this example, the acquired ticket for the baseball event is offered for sale for access to the baseball event from the third inning through completion of the event. In this example, the subsequent sale price is established in accordance with Equation 1 as follows: SSP=$54.00−(54× 2/9)=$42 where the adjustment value is 54 and the elapsed time is equal to having access to the baseball event from the third inning through completion of the baseball event. Therefore, the acquired ticket may be offered for sale at the subsequent sale price, which, in this case is a reduced price compared to the first sale price, before the start time of the baseball event, and, if the ticket is bought by the purchaser at this time, the purchaser may attend the game from the third inning through completion.

In another example, the ticket for the baseball event is offered for sale for access to the baseball event from the sixth inning through completion of the event. In this example, the subsequent sale price is established in accordance with Equation 1 as follows: SSP=$54.00−(54× 5/9)=$24 where the adjustment value is 54 and the elapsed time would be equal to having access to the baseball event from the sixth inning through completion of the baseball event. Therefore, the ticket may be offered for sale at the subsequent sale price, which, in this case is a reduced price compared to the first sale price, before the start time of the baseball event, and, if the ticket is bought by the purchaser at this time, the purchaser may attend the game from the sixth inning through completion.

Having thus described methods for event ticketing, there is provided a system for event ticketing in accordance with one aspect of the present disclosure, with the system generally indicated at 10. The system 10 includes at least one non-transitory computer-readable storage medium 12 and at least one processor or microprocessor 14. The at least one non-transitory computer-readable storage medium 12 includes instructions encoded thereon that when executed by the at least one processor 14 operates to implement one or more of the methods described above.

The system 10 utilizes the non-transitory computer-readable storage medium 12 and the at least one processor 14 to acquire a ticket for an event, determine a start time of the event, determine a first sale price, which may also be referred to as FSP, of the ticket for the event, establish a subsequent sale price, which may also be referred to as SSP, of the ticket for the event, and offer the ticket for sale at the subsequent sale price at a time after the start time of the event.

In another example, the system 10 utilizes the non-transitory computer-readable storage medium 12 and the at least one processor 14 to acquire a ticket for an event, determine a start time of the event, determine a first sale price of the ticket for the event, establish a subsequent sale price of the ticket for the event, and offer the ticket for sale at the subsequent sale price prior to the start time of the event for a pre-determined portion of access to the event after the start time of the event.

As stated above, the subsequent sale price of the acquired ticket represents the sale price of the acquired ticket after a start time of the event associated with the acquired ticket. Further, and as stated above, that the subsequent sale price may be established in any suitable manner. As such, and in one example, the subsequent sale price may also be referred to as sale price, and the sale price does not have to be related to the first sale price in any manner whatsoever and may be established in any suitable manner.

The at least one non-transitory computer-readable storage medium 12 having instructions encoded thereon and the at least one processor 14 are configured to operatively communicate with a website and/or a mobile application through an electronic device 16 (FIG. 2) as further described below. Although the at least one non-transitory computer-readable storage medium 12 having instructions encoded thereon and the at least one processor 14 are configured to operatively communicate with a website and/or a mobile application, it is to be understood that the at least one non-transitory computer-readable storage medium 12 having instructions encoded thereon and the at least one processor 14 may be configured to operatively communicate with any suitable mechanism to offer and purchase acquired event tickets.

With reference to FIG. 2, and in one example, the system 10, including the at least one non-transitory computer-readable storage medium 12 and the at least one processor 14, is embedded within the mobile application. In this example, the mobile application is an event ticketing application 18 (FIG. 2) executed by the electronic device 16. Although the system 10 has been described as being embedded within the event ticketing application 18, it is to be understood that the system 10 may be operated via any suitable mechanism, such as, for example, from a web server. As discussed in detail below, the system 10 operatively communicates with the event ticketing application 18 to offer and purchase tickets for events. As such, the event ticketing application 18 may be utilized to offer and purchase tickets via the system 10 in accordance with the teachings of the present disclosure.

In this example, the electronic device 16 is a smart phone; however, it is to be understood that the electronic device 16 may be any electronic device capable of executing software instructions. For example, and not meant as a limitation, the electronic device 16 may be a computer, laptop computer, or the like. The electronic device 16 operatively communicates with the event ticketing application 18 and the system 10 by executing instructions encoded on the at least one non-transitory computer-readable storage medium 12 via the at least one processor 14 of the system 10 and/or other logic.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

As shown in FIG. 2, the electronic device 16 is connected to a wireless network 20. The wireless network 20 may include other networks such as a wired network and/or other wireless cellular networks.

Having introduced the electronic device 16 running the event ticketing application 18 in operative communication with the system 10, the use and operation of the system 10, electronic device 16, and the event ticketing application 18 are now described. A user downloads the event ticketing application 18 onto the electronic device 16. The user activates or opens the event ticketing application 18 by clicking on an event ticketing application icon (not shown) and the user is brought to a login page 22. Alternatively, the event ticketing application 18 may be voice activated after being downloaded and the user may be brought to the login page 22.

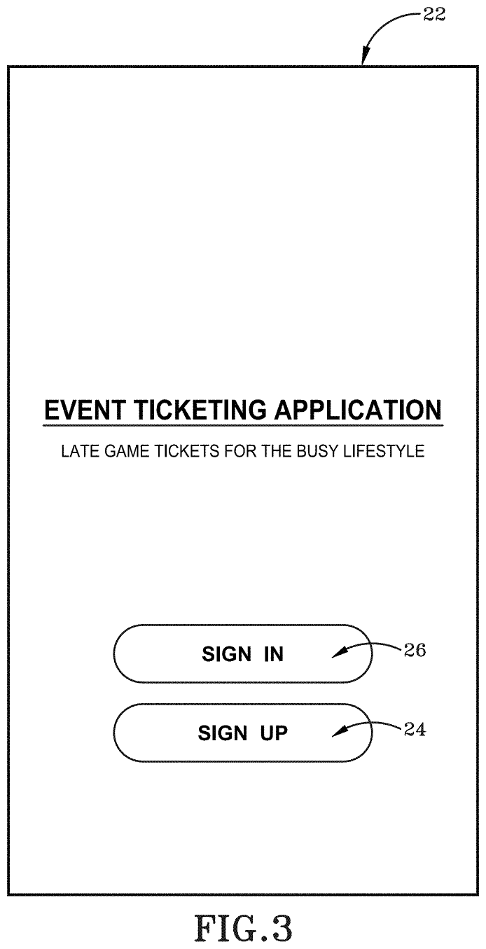

FIG. 3 illustrates an exemplary screen view of the login page 22 of the event ticketing application 18 displayed on the electronic device 16. The login page 22 includes a “sign up” button 24 and a “sign in” button 26. The “sign up” button 24 may be pressed by a user to create an event ticketing application account. For example, and not meant as a limitation, pressing the “sign up” button 24 provides a way for a user to enter their first and last name (not shown), city (not shown), state (not shown), country (not shown), email (not shown) and any other suitable information (not shown) needed to create an event ticketing application account.

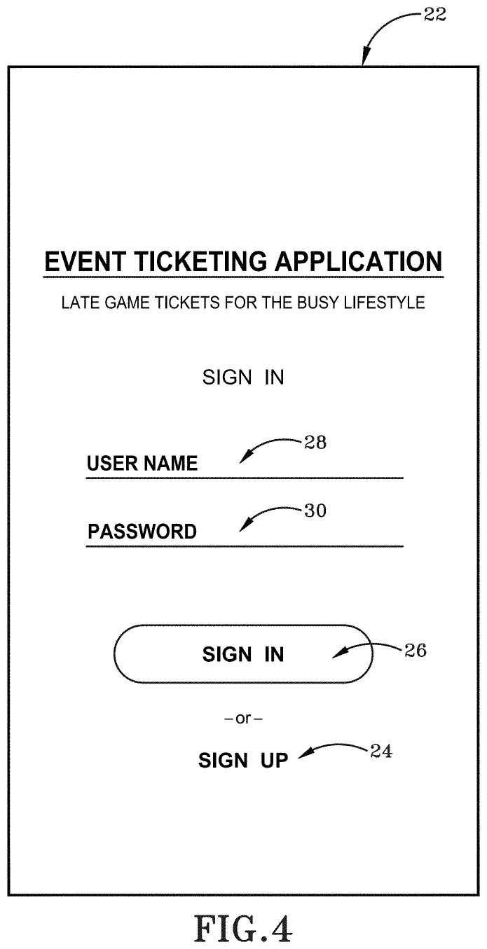

In the event the user already has an event ticketing application account, the “sign in” button 26 is pressed by the user and the user is prompted to enter a user name in a user name text box 28 and a password in a password text box 30, which is generally shown in FIG. 4.

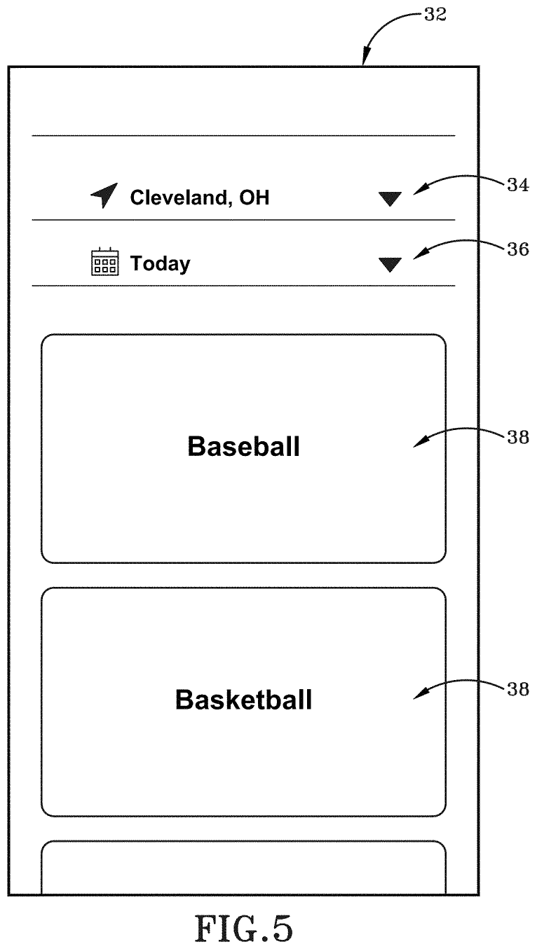

Once the user creates an account and signs into the event ticketing application 18, or signs into the event ticketing application 18 by providing their username and password, the user is brought to a menu screen 32. FIG. 5 illustrates an exemplary menu screen 32 including a location selector button 34 used to select a location of an event, a date selector button 36 used to select a date for an event, and an event type selector button 38 used to select a type of event. The location selector button 34, the date selector button 36, and the event type selector button 38 provide access to data acquired by the system 10. For example, and not meant as a limitation, the data includes, but is not limited to, a plurality of event types at a plurality of locations on a plurality of dates, as well as the first sale price, subsequent sale price, and/or the sale price of the tickets and current status for each event as further described below.

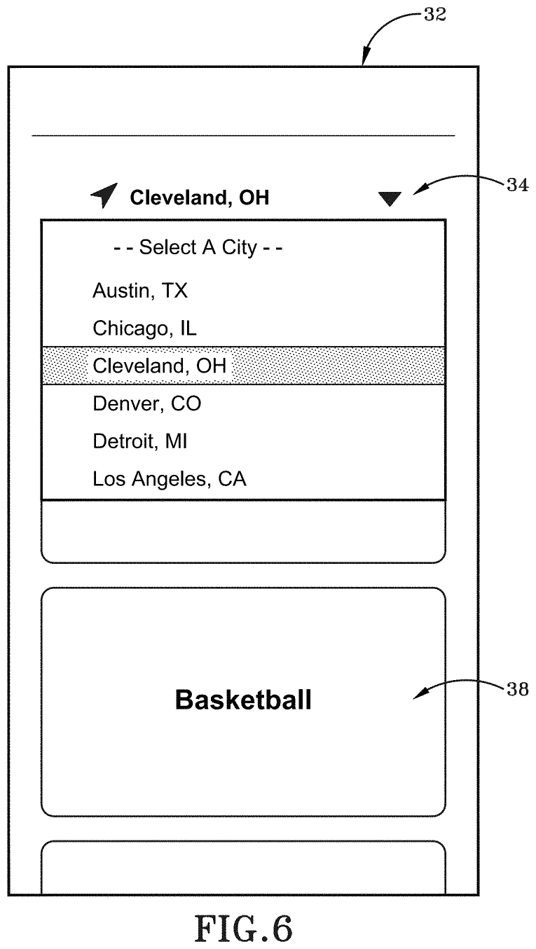

The location selector button 34 is pressed by the user allowing the user to select a location of an event, which is shown generally in FIG. 6. For example, and not meant as a limitation, the user selects a city in the United States such as Cleveland, Ohio. Although the location selector button 34 has been described as providing access to a list of cities of the United States, the location selector button 34 may provide access to any location, including, but not limited to, any country, region, state, city, or the like. Further, the location selector button 34 may be configured to provide results including surrounding areas of the selected city. For example, and not meant as a limitation, if the user selects Cleveland, Ohio, as the desired location, the results may include events in Cleveland, Ohio, as well as events within a radius of Cleveland, Ohio. It is to be understood that the radius may be any suitable radius.

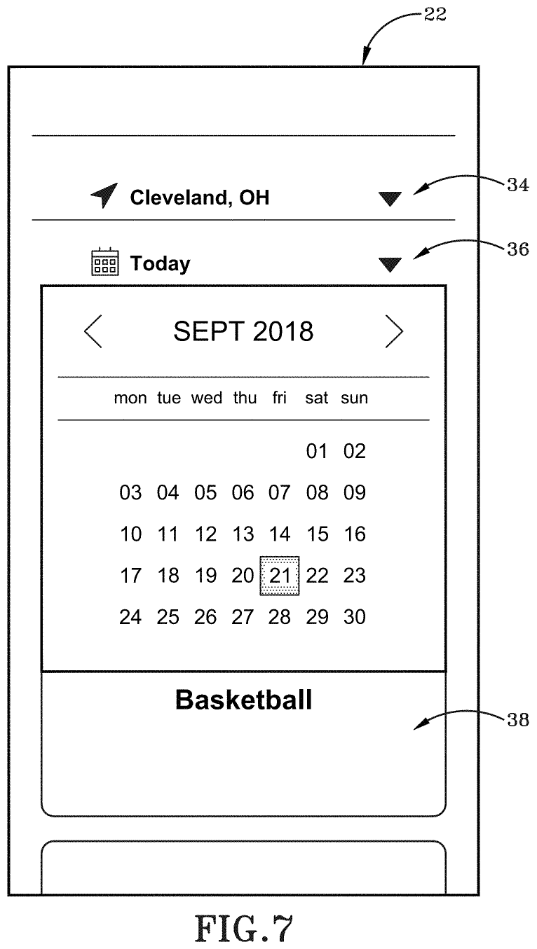

The date selector button 36 is pressed by the user allowing the user to select a date of an event, which is shown generally in FIG. 7. For example, and not meant as a limitation, the user may select a date such as Sep. 21, 2018; however, any suitable date may be selected.

The event type selector button 38 is pressed by the user allowing the user to select the type of event, which is shown generally in FIG. 5 as a baseball event and a basketball event. For example, and not meant as a limitation, the user may select a sports event, such as baseball, basketball, football, or any other sports event. Although the event type selector button 38 has been described as providing access to a list of sports events, the event type selector button 38 may provide access to any event type, including, but not limited to, general entertainment events, such as concerts or the like.

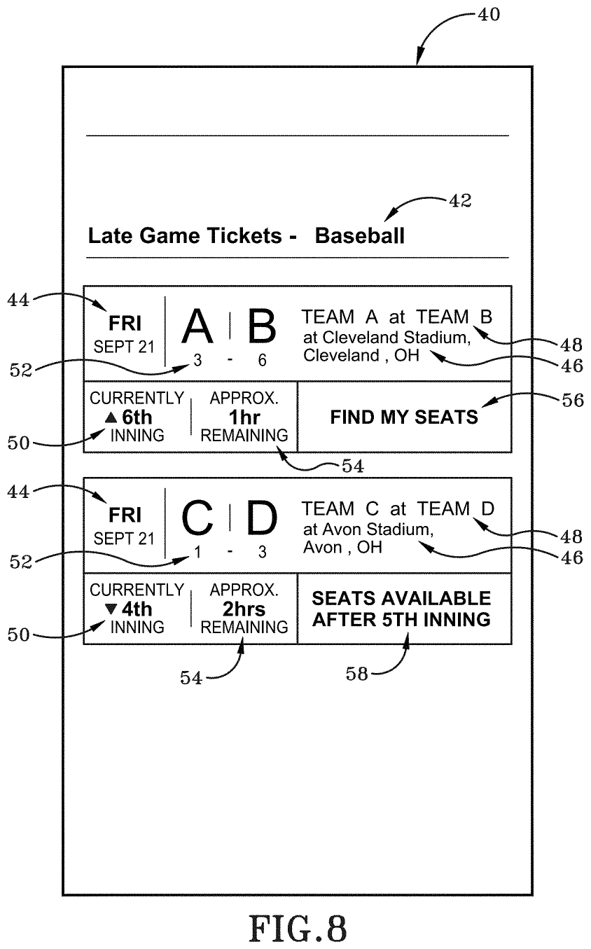

After the user selects the desired location, the desired date, and the desired event type, the user is brought to an event screen 40 which displays data based, at least in part, on the user's location, date, and event type entered into the event ticketing application 18. FIG. 8 illustrates an exemplary screen view of the event screen 40 of the event ticketing application 18 displayed on the electronic device 16. In this example, the user selected Cleveland, Ohio, as the desired location, September 21 as the desired date, and baseball as the desired event type. The event screen 40 provides a list of results based on the user's selections and based on the ticket inventory acquired by the system 10. For example, and not meant as a limitation, the event screen 40 of FIG. 8 displays two baseball events in or near Cleveland, Ohio, taking place on September 21. The event screen 40 includes an event type identifier 42, a date identifier 44, a location identifier 46, a team identifier 48, a status identifier 50, a current score identifier 52, an estimated remaining time identifier 54, a seat selector button 56, and a seat availability identifier 58.

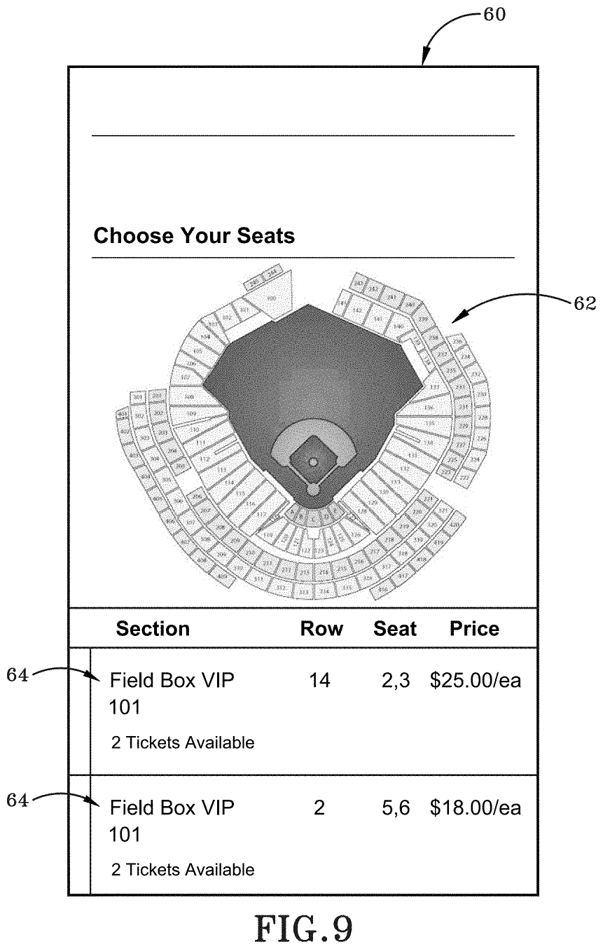

The location event type identifier 42 identifies the selected event type. As shown in FIG. 8, the event type is baseball. The date identifier 44 identifies the selected date. As shown in FIG. 8, the date is July 20. The location identifier 46 identifies the locations that the system 10 produced. As shown in FIG. 8, the locations are Cleveland, Ohio, and Avon, Ohio. The team identifier 48 identifies the teams that are involved with the event type. As shown in FIG. 8, the teams competing in a first baseball event are Team A and Team B, and the teams competing in a second baseball event are Team C and Team D. The status identifier 50 identifies the status of the event type. As shown in FIG. 8, the first baseball event is currently in the sixth inning and the second baseball event is currently in the fourth inning. The current score identifier 52 identifies the current score of the baseball event. As shown in FIG. 8, the score of the first baseball event is 3-6, and the score of the second baseball event is 1-3. The estimated remaining time identifier 54 identifies an estimated remaining time of the baseball events. As shown in FIG. 8, the first baseball event has approximately one hour remaining until completion and the second baseball event has approximately two hours remaining until completion. The seat selector button 56 is pressed by a user bringing the user to a seat selection screen 60. FIG. 9 illustrates an exemplary screen view of the seat selection screen 60. The seat availability identifier 58 identifies whether seats are available. As shown in FIG. 8, seats are not available for purchase until after the fifth inning for the second baseball event, which means that the tickets are being offered for sale at the subsequent sale price at a time subsequent to the start time of the second baseball event.

The seat selection screen 60 displays data based, at least in part, on the acquired ticket inventory. With continued reference to FIG. 9, the seat selection screen 60 includes a seat map identifier 62 and available ticket information 64. The seat map identifier 62 includes details regarding the seating layout of the event location. The available ticket information 64 includes information regarding particular seats as well as the subsequent sale price of the tickets. As shown in FIG. 9, two Field Box very-important-person (VIP) tickets are available in row 24, seats 2 and 3 at a subsequent sale price, or sale price, of $25.00 each, and two Premier Club E tickets are available in row 2, seats 5 and 6 at a subsequent sale price, or sale price, of $18.00 each.

The user selects the desired tickets to purchase the tickets. For example, and not meant as a limitation, if the user selects the two Premier Club E tickets available in row 2, seats 5 and 6 at a subsequent sale price of $18.00 each, the user is brought to an order information screen 66.

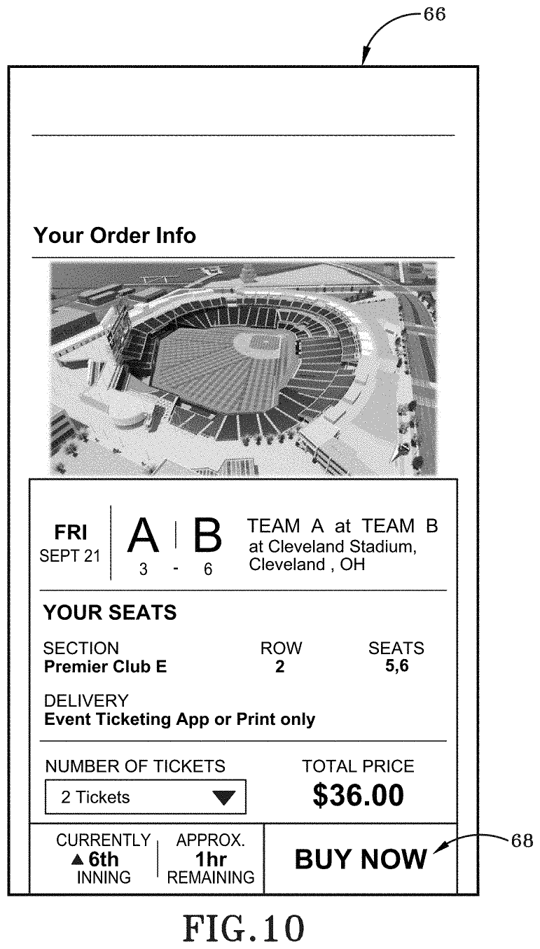

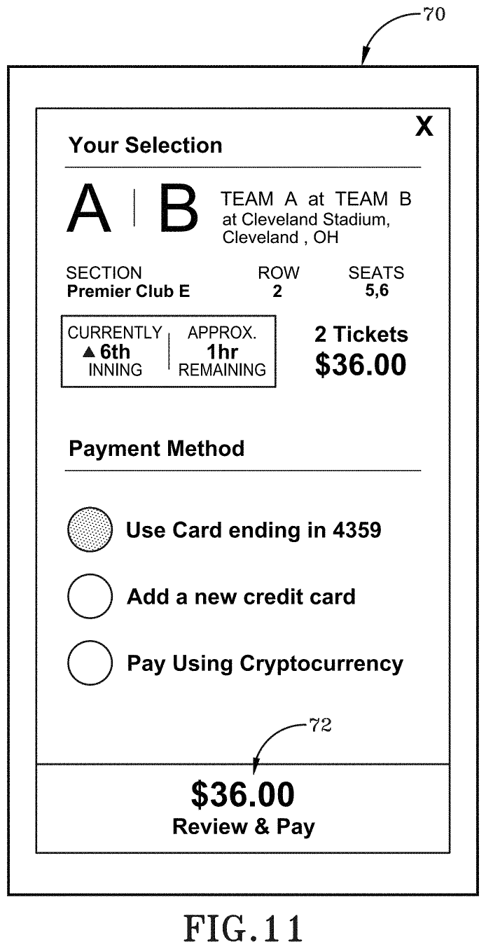

FIG. 10 illustrates an exemplary screen view of the order information screen 66. The order information screen 66 includes information related to the purchase of the tickets and includes a buy now button 68. If the user presses the buy now button 68, the user is brought to a payment screen 70. The event ticketing application 18 is configured to process payments via credit card or cryptocurrency, such as Bitcoin. Although the event ticketing application 18 has been described as processing payments via credit card or cryptocurrency, it is to be understood that the payments may be processed in any suitable manner.

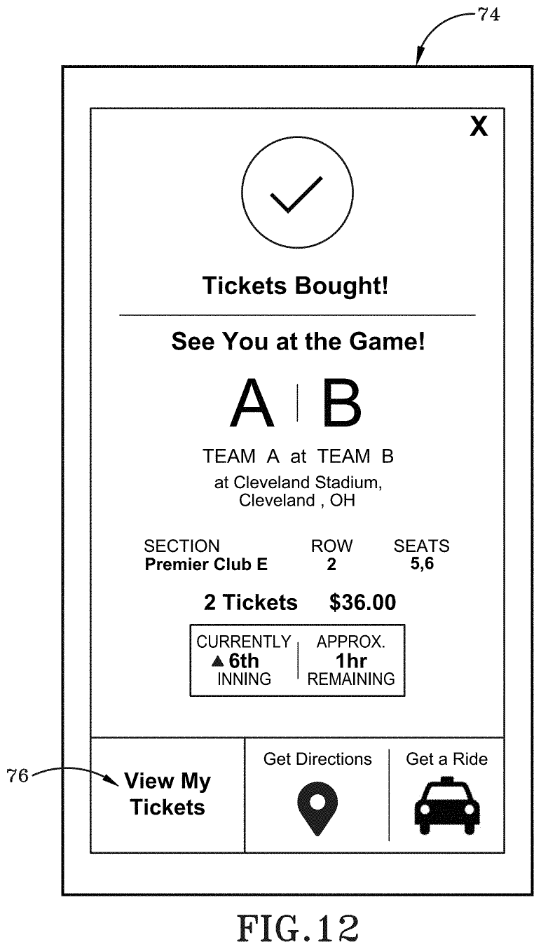

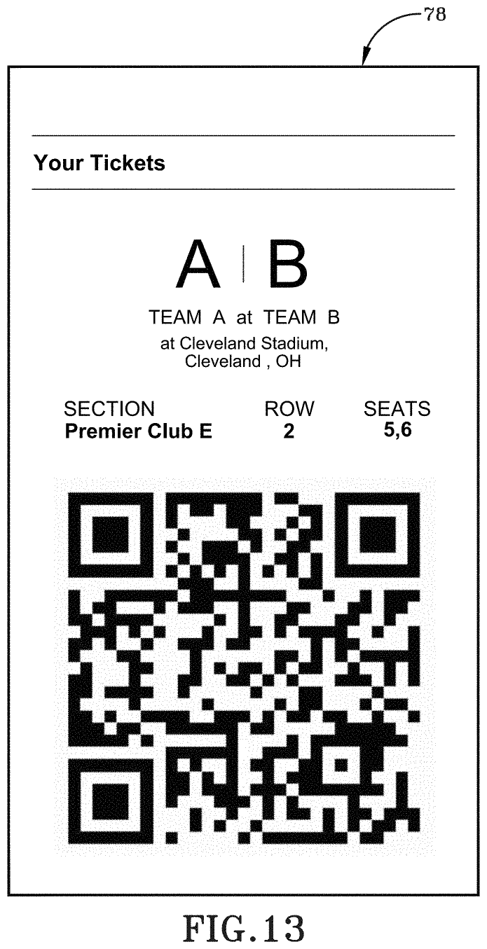

FIG. 11 illustrates an exemplary screen view of the payment screen 70. The payment screen includes information regarding payment for the selected tickets and includes a pay button 72. If the user presses the pay button 72, the user is brought to a receipt screen 74. FIG. 12 illustrates an exemplary screen view of the receipt screen 74. The receipt screen 74 includes details of the user's purchase and includes a view my tickets button 76. If the user presses the view my tickets button 76, the user is brought to a ticket screen 78. FIG. 13 illustrates an exemplary screen view of the ticket screen 78. The ticket screen 78 includes the tickets that were purchased by the user. The purchased tickets are utilized by the user to access the selected event.

Although certain exemplary configurations of the event ticketing application 18 have been described, it is to be entirely understood that the event ticketing application 18 may take on any other suitable configurations.

It is further envisioned that the event ticketing application 18 may be configured to utilize blockchain technology, which is defined as a growing list of records, called blocks, which are linked using cryptography. Cryptography is defined as the practice and study of techniques for secure communication in the presence of third parties. With blockchain technology, each block contains a cryptographic hash of the previous block, a timestamp, and transaction data.

For example, and not meant as a limitation, the blockchain technology may be utilized to determine locations of purchasers and sellers of tickets. If a possessor of a ticket sells a ticket during an event, the blockchain technology may be utilized to track where the seller is when they sell the ticket during the event. If the seller of the ticket is still within the premises of the event, the event ticketing application 18 may be configured to restrict the sale of the ticket until the seller is outside of the premises of the event. In another example, the blockchain technology may be utilized to confirm whether a purchaser of a ticket is seated in the correct area of the event. In another example, the blockchain technology may be utilized to confirm information, such as, for example, an identity of the seller, whether the ticket is still available for purchase, and whether the ticket has been utilized to gain access to the event. In another example, the blockchain technology may be utilized to, among other things, calculate and confirm event times and calculate ticket pricing based on the duration of the event. Therefore, the blockchain technology may be utilized to, among other things, prevent fraud and allow for more accurate timing and pricing. Blockchain may further be utilized as a way to facilitate fiat currency to cryptocurrency to fiat currency transactions or facilitate the use of cryptocurrency coins, such as, for example, bitcoin or any other token/coin. Fiat currency is defined as a currency without intrinsic value that has been established as money, typically by government regulation. Blockchain may also be used to facilitate smart contracts between buyers and sellers to combat against fraudulent transactions and counterfeit ticketing. Those tickets placed on or sold through the blockchain will be recorded against a non-corruptible ledger which can neither be changed or manipulated once loaded to the blockchain. This will guarantee no purchase will be duplicated. Further, blockchain may be utilized as tool to aid in preventing fraudulent ticketing.

It is further envisioned that the systems and methods of the present disclosure may be utilized with providers of events, such as, for example, a sports team. As such, and in this example, the systems and methods of the present disclosure may be integrated with the sports team's technology offering the sports team a turnkey solution for offering tickets for sale before and after the start time of their events. For example, the sports team serves as an API source with suitable hooks/connections. Information and/or data from the API is pushed into an interactive user interface, such as a dashboard. The information and/or data includes, but is not limited to, current/upcoming games, dates of games, real time game clock, and available ticket information (e.g., sections, rows, seats, and prices of the tickets). The interactive user interface, or dashboard, processes the information and/or data received from the sports team allowing the sports team access to the processed information. The sports team can manipulate the processed information and/or data via front-end dashboard controls. Some exemplary dashboard controls include, but are not limited to, selecting games and associated dates; selecting when tickets go on sale (i.e., before and after the start time of the game; selecting when access via tickets is available; selecting which tickets/sections are available; selecting a default pricing for the tickets (e.g., if the game is in the third quarter, the price of the ticket is fifty percent less than the face value of the ticket; selecting custom pricing for the tickets; selecting how the access is granted (e.g., access granted based on the real time clock of the game; and selecting ticket thresholds that trigger ticket discounts. The tickets, based on the processed information and/or data are made available to user interfaces where purchasers can buy the tickets. The purchase can be handled in any suitable manner. Purchase information is sent to the sports team for review and/or record keeping. Purchase information includes, but is not limited to, the sale price of the tickets, demographic information of the user, or any other suitable information.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method for event ticketing comprising:
acquiring a ticket for an event;
determining a start time of the event;
establishing a sale price of the ticket for the event;
offering the ticket for sale at the sale price subsequent to the start time of the event; and
providing a purchaser of the ticket access to the event after the start time of the event.

2. The method of claim 1, further comprising:
determining a face value of the ticket; and
establishing the sale price to be higher than the face value.

3. The method of claim 1, further comprising:
determining a face value of the ticket; and
establishing the sale price to be lower than the face value.

4. The method of claim 1, further comprising:
dynamically adjusting the sale price after the start time of the event.

5. The method of claim 1, wherein the acquiring the ticket for the event is accomplished via obtaining the ticket from at least one of a primary ticket vendor, a secondary ticket vendor, and a person who previously purchased the ticket.

6. The method of claim 1, further comprising:
providing an interface; wherein the acquiring the ticket for the event is accomplished via importing the ticket into a database via the interface.

7. The method of claim 1, further comprising:
allowing the purchaser of the ticket to purchase the ticket through operative communication with a user interface.

8. The method of claim 7, further comprising:
providing a website as the user interface.

9. The method of claim 7, further comprising:
providing a mobile application as the user interface.

10. The method of claim 1, further comprising:
providing the purchased ticket in electronic or physical form.

11. A method for event ticketing comprising:
acquiring a ticket for an event;
determining a start time of the event;
establishing a sale price of the ticket for the event;
establishing a pre-determined portion of access to the event;
offering the ticket for sale at the sale price at the sale price prior to the start time of the event; and
providing a purchaser of the ticket the pre-determined portion of access to the event.

12. The method of claim 11, further comprising:
determining a face value of the ticket; and
establishing the sale price to be higher than the face value.

13. The method of claim 11, further comprising:
determining a face value of the ticket; and
establishing the sale price to be lower than the face value.

14. The method of claim 11, further comprising:
dynamically adjusting the sale price prior to the start time of the event.

15. The method of claim 11, wherein the acquiring the ticket for the event is accomplished via obtaining the ticket from at least one of a primary ticket vendor, a secondary ticket vendor, and a person who previously purchased the ticket.

16. The method of claim 11, further comprising:
providing an interface; wherein the acquiring the ticket for the event is accomplished via importing the ticket into a database via the interface.

17. The method of claim 11, further comprising:
allowing the purchaser of the ticket to purchase the ticket through operative communication with a user interface.

18. The method of claim 17, further comprising:
providing a website as the user interface.

19. The method of claim 17, further comprising:
providing a mobile application as the user interface.

20. The method of claim 1, further comprising:
providing the purchased ticket in electronic or physical form.
